(19) United States
(12) Patent Application Publication
(10) Pub. No.: US 2016/0165200 A1
(43) Pub. Date: Jun. 9, 2016

(54) MEASUREMENTS OF CINEMATOGRAPHIC PROJECTION

(71) Applicant: HIGHLANDS TECHNOLOGIES SOLUTIONS, Valbonne (FR)

(72) Inventor: Francois Helt, Seugy (FR)

(21) Appl. No.: 14/907,612

(22) PCT Filed: Aug. 1, 2013
(86) PCT No.: PCT/FR2013/051867

§ 371 Date: Jan. 26, 2016

(51) Int. Cl. H04N 9/31

(52) U.S. Cl. CPC H04N 9/3194; H04N 9/3182

(57) ABSTRACT

A method for determining the operation of an image projector for projecting images onto a screen of a projection room. In particular, the method is implemented by computing means and comprises the following steps: driving the projector so as to project onto the screen a test card comprising a distribution of patterns of different hues, acquiring an image of the test card on the screen by a picture taking apparatus, and applying a processing of the image acquired, so as to determine at least one deviation of chrominance of the image acquired with respect to a predefined number of colors.

The present invention relates to an improved measurement of cinematographic projection.

Professional film distribution in theaters often requires quality control of the projection. This need has increased since the advent of digital cinematographic projection, as very precise specifications need to be met. These include the level and uniformity of the illumination, colorimetry, focus, etc. These may be settings imposed by technical standards or recommendations (AFNOR and/or ISO), or regulatory constraints such as those in France.

Since the advent of digital, adjustments need be made more frequently than in the past. If properly done, they also provide better management of lamp wear, which saves money. Since the switch to digital also automates the preparation and launch of film showings, movie theater chains have reduced their technical staff on site, including projectionists, and are currently seeking remote testing solutions.

The instruments necessary for such testing are generic instruments for measuring brightness and color, called “luminance meters” and “colorimeters”. They are not specifically developed for measurements over large areas such as movie screens, and only provide local measurements. Global assessments such as uniformity require multiple readings, associated with calculations. Human intervention is also necessary for setting the measurement points on the projected image, collecting the measured data, and combining the data. The measurements take time and are prone to evaluation errors. It is difficult, if not impossible, to conduct the tests remotely.

More particularly, existing measurement devices cannot be permanently installed at a fixed location. To obtain all the necessary data for calibrating or evaluating a projection, it is necessary to use systematic manual aiming, where an operator directs the measurement device in the direction of the screen area he considers appropriate for each reading.

In addition, the data collected by conventional devices are essentially more or less numerous values over the entire visible spectrum, as well as the corresponding luminance and color calculation data. These elements can sometimes be saved, but usually no local comparison or verification of the calculation is possible. Thus, to obtain and compare data from multiple points, usually the saved elements have to be re-read on a separate computing system, which takes time and is complex.

In summary, there are no existing devices dedicated to the measurement of cinematographic projection. Current testing is mainly carried out with generic measurement devices and with several human operators, using lengthy and approximative procedures.

The present invention improves the situation.

For this purpose, it proposes a method for determining the operation of a projector of images on a screen of a projection room. The method as defined in the invention is implemented by computing means and comprises the steps of:
controlling the projector so as to project on the screen a test card comprising a distribution of patterns of different hues,
capturing a digital image of the test card on the screen by an image capturing device,
processing the captured image to determine at least one chrominance deviation of the captured image with respect to a predefined number of colors.

Thus, the invention proposes capturing a digital image of the test card as projected on the screen, in order to be able to process this image by computer (for example statistical chrominance estimates and/or luminance comparisons, or other processing), possibly also to issue instructions for projector adjustments based on the outcome of this computer processing.

In one exemplary embodiment, said test card comprises at least twenty-four patterns of different colors (or a repetition of these twenty-four patterns), comprising:
at least the hues of human skin tones, the sky, foliage, and possibly flowers, brick, etc., and
six shades of gray.

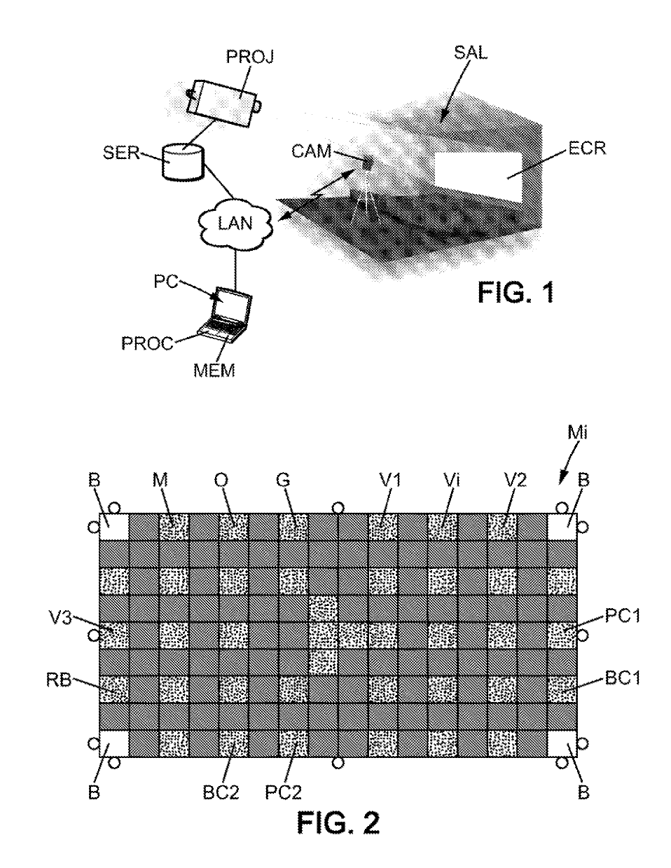

These patterns are distributed on a background of uniform neutral color (similar to the middle gray in FIG. 2 discussed below). More particularly, in an exemplary embodiment, the aforementioned test card comprises, at least in a peripheral portion, a distribution of said colored patterns, each alternating with homologous patterns of middle gray. The hues of the test card, the number of hues, and their distribution are advantageously chosen so as to statistically characterize the full colorimetry of the projection.

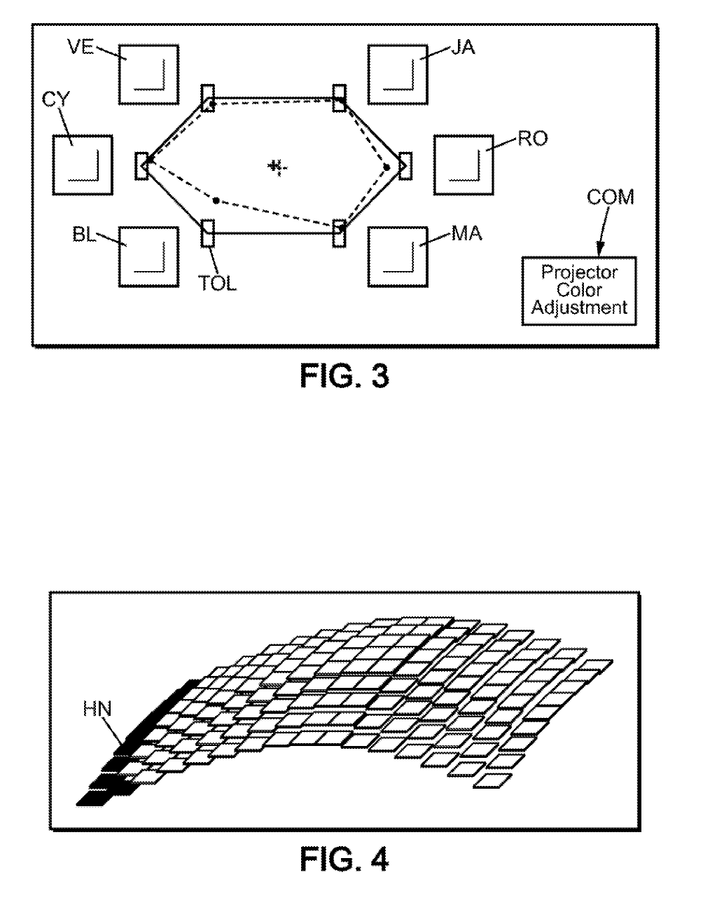

In one particular embodiment, the calculated colorimetric rendering is presented relative to six reference colors: the primary colors red, green, blue, and the complementary colors yellow, magenta, and cyan, as will be discussed below with reference to FIG. 3.

Advantageously, the chrominance deviation between each actual hue of the test card (given by the computer processing means) and the hue measured in the test card projection (provided by the image capturing device) is determined for each of the six reference colors. In one exemplary embodiment, an average is then applied over all the hue deviations of the test card, for each of the six reference colors. The average deviation for each reference color can then be compared to a predefined tolerance threshold. This comparison makes it possible to check conformity of the projection settings. In case of a deviation greater than the tolerance threshold, the measured values collected can be used for manually adjusting the projection or, in a more sophisticated variant, a direct command can be sent to a computerized adjustment module for the projector in order to perform this adjustment automatically.

Indeed, as discussed below with reference to FIG. 3, an interface signal prompts a user to confirm a command (command COM of the screenshot in FIG. 3) to adjust the projector chrominance automatically.

Preferably, the patterns of the projected test card are rectangles separated by black lines of predetermined thickness.

In addition, upper right, lower right, upper left, and lower left edge patterns are white in color to assist with capturing an image of the entire test card.

In one exemplary embodiment, the same test card can further be used for determining a luminance distribution on the screen, or alternatively, a simple white image projected on the screen can be used.

For example, the luminance distribution can be given by:
two coordinates of latitude and longitude on the screen, and
a proportion of light intensity received at each of these screen coordinates.

In one embodiment, determination of a luminance lower than a threshold in at least a portion of the screen may cause the generation of a man/machine interface signal of non-conformity of the projector settings. For example, an area of the screen in which the luminance is below a threshold may be considered as noncompliant with certain standards of movie theater projection, which then has the effect of imposing certain adjustments to the projector (for example centering relative to the screen, or centering of the lamp relative to the mirror), or imposing a cleaning of the projection system (in the case of a spot identified in the image projection), or imposing a change of the lamp, which may be old.

In addition, the method may further comprise a preliminary step of calibrating the image capturing device, one time only, prior to its use on site in the projection room.

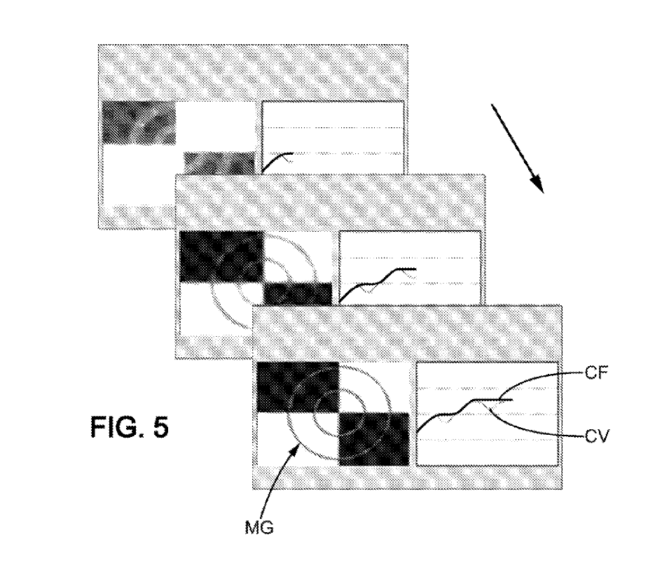

The method may further include a step of progressively adjusting the focus of the projector by projecting a contrasting test card, as discussed below with reference to FIG. 5.

The invention also relates to a computer program comprising instructions for implementing the above method, when the program is executed by a processor (for example the processor PROC of the aforementioned computing means such as the computer PC in the embodiment represented in FIG. 1).

The invention also relates to a system for determining the operation of a projector of images on a screen of a projection room, comprising:
a device (such as the server SER of FIG. 1) for controlling the projector so as to project on the screen a test card comprising a distribution of patterns of different hues,
an image capturing device for capturing a digital image of the test card on the screen,
computing means (such as the computer PC of FIG. 1, or a tablet, or some other means) connected to the image capturing device in order to process the captured image and determine at least one chrominance deviation of the captured image with respect to a predefined number of colors.

Thus, the present invention proposes in particular:
the use of an image capturing device, such as a simple digital camera or digital videocamera, with image processing enabling more accurate and more complete measurements obtained more quickly than in the prior art. The entire projected image is captured and then the collected data are analyzed quickly and according to specially adapted processing procedures;
the calibration of the image capturing device used in an embodiment of the invention, in order to compensate for its own characteristics and thus to provide valid measurement data.

The resulting image is refreshed regularly and displayed on a screen of a tablet, computer, or any other device with a screen, together with the measurement readings.

This provides major advantages in measuring the brightness and color of the projection. The device also allows complete control of other projection parameters, including the projector focus. Data collected over the entire area of the projected image are analyzed to obtain luminance and chrominance measurements at specific points on the screen.

By displaying all areas of the projected image and associating the appropriate image processing, it is possible to characterize the two-dimensional profile of chrominance and/or luminance and its derivatives, as discussed below with reference to FIG. 3 and/or FIG. 4, described below.

All operations are performed very quickly with no need for systematic manual aiming by a human operator.

All results and displays can be sent via an existing computer network, allowing remote control of adjustments.

All measurements can be saved for later review, or for providing a projection change log.

The invention thus avoids the disadvantages of the prior art. In particular, as all measurements are grouped in a single processing, all control operations are possible, recordable, and achievable remotely.

Other features and advantages of the invention will be apparent from the following description of some exemplary embodiments given by way of illustration and not limitation, and from examining the accompanying drawings in which:

FIG. 1 illustrates a system for implementing the invention,

FIG. 2 shows a test card projected on a screen in order to carry out the invention,

FIG. 3 is a screenshot on the computer PC of FIG. 1, representing the chrominance deviation between the projected image and the ideal image, depicted as the resulting deviation for six reference colors,

FIG. 4 is a screen shot on the computer PC of FIG. 1, representing the luminance distribution on the screen and areas where the luminance is too low (HN—not meeting the standard),

FIG. 5 shows three successive screen shots on the computer PC of FIG. 1, representing a gradual focusing of the projector controlled by the computer PC, and

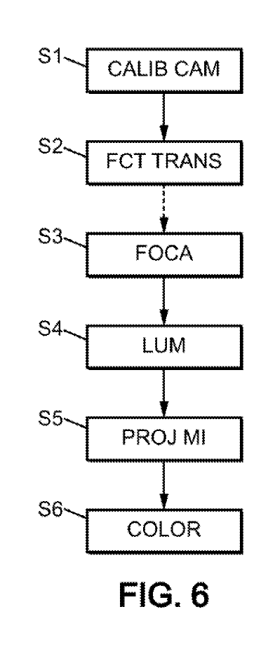

FIG. 6 shows the main steps of the method according to the invention, in one embodiment.

A system is described below, with reference to FIG. 1, for implementing a method within the meaning of the invention, comprising:
an image capturing device such as a digital videocamera CAM in the example described,
a screen ECR, said videocamera filming the screen,
a projection device PROJ, projecting the image of a test card on the screen.

The system is preferably implemented in the projection room SAL where the projector PROJ is housed, in order to be within the projection conditions of the projector and the viewing conditions of the spectators in the room SAL.

The videocamera CAM is positioned in line with the screen ECR, for example:
in the middle of the seats in the room SAL, in order to test image quality using a simple mobile videocamera CAM,
or, in a variant for a fixed installation, at the back of the room near the projection booth PROJ (but still in the room).

The videocamera CAM is connected (via a wired or wireless connection, via WiFi for example) to a computer PC (for example a laptop) or tablet, typically comprising a processor PROC and a working memory MEM, to enable processing the measurements to obtain adjustments to be applied to the projector to bring the projection on the screen ECR in compliance with standards in terms of chrominance, luminance, focus, etc. The computer PC may further comprise a screen enabling an operator to visualize the adjustment recommendations for the projector PROJ. In one advantageous embodiment, the projector PROJ can be controlled by a server SER (for the images it projects, but also for its settings such as focus, chrominance, etc.), this server SER being connected to the computer PC for example via a local network LAN (FIG. 1). Thus, based on the results of the processing performed by the computer PC on the digital image captured by the videocamera CAM, the computer PC can display information concerning the conformity of projector operation and possibly propose adjustment recommendations to a user of the computer PC. If the user approves these adjustments (as will be discussed in the example illustrated in FIG. 3), the computer PC can then send an adjustment command to the server SER via the local network LAN, to adjust the projector, for example its chrominance, focus, etc.

Preferably, the digital videocamera CAM has the following properties:
high resolution for distinguishing fine details,
low noise level,
high dynamics, to enable at least 12-bit processing of data obtained from the videocamera,
very good stability of the sensor containing the light-receiving photosites (including good thermal stability) and of its analog-to-digital converter.

The videocamera yielding satisfactory results for the tests comprises a CCD sensor of 3326 by 2504 pixels, with a Bayer filter array. The CCD sensor is cooled by Peltier effect to limit noise and to stabilize the analog-to-digital conversion. The videocamera built around this sensor was designed primarily for capturing astronomical images.

Referring to FIG. 1, the videocamera CAM is first installed so that the image it captures covers the entire projection screen ECR. Referring to FIG. 2, a test card MI with centering cross-hairs is aligned with a marker superimposed on the image to allow better centering the screen capture. We seek the best conditions for a capture of the projected image that covers most of the videocamera CAM sensor, is fairly well centered, and without the projected image exceeding the sensor surface. For this purpose, white image edge patterns (top left, bottom left, top right, and bottom right) are used that are to appear in the captured image. This alignment is done one time only for a given fixed installation.

The test card MI, of known geometry and ideal hues, is shown in FIG. 2. It consists of a black grid delimiting middle gray rectangles and rectangles of colors B, M, O, G, V1, Vi , V2, etc. The hues chosen for these patterns are the ones used for analyzing camera quality;

they correspond to reference hues: brick red RB, leaf green V3, sky blue BC1, BC2, Caucasian skin tones PC1, PC2, black skin tones, etc. As an illustration, the first row of rectangles of different shades of middle gray contains rectangles denoted B for white; M is Brown; O for ocher; G for dark gray; V1 for a first green; Vi for violet; V2 for a second green. In general, the number and dimensions of the rectangles in the test card MI are selected to achieve a compromise between the quality of the geometric detection and the possibility of averaging over a large number of pixels, as described below.

The image of the test card is analyzed and each rectangle is precisely identified. After a rapid analysis, the processing within the meaning of the invention detects all the rectangles one after another and calculates their dimensions and position. In this regard, the thickness of a black line separating two rectangles is also important, in the sense that it should be about 2 to 3 pixels as captured by the videocamera CAM. The processing also checks that the projected image does not exceed the boundaries of the videocamera sensor.

Each of the rectangles is identified individually in order to eliminate possible deformations due to cinematographic projection or to the lens used by the videocamera. For keystone distortion caused by off-center placement of the projector, or distortion caused by the use of a curved screen, or deformation due to the lens, or any combination of possible deformations, the identification of each point of the screen is much more accurate than when a human operator is aiming.

In addition, the hue of the rectangles allows a good approximation in detecting the color consistency in the projection. The large number of rectangles (particularly light gray) allows calculating the brightness and possible drift from the reference white B. The test card MI of FIG. 2 shows repeated hues at the top and bottom of the test card figure, but with twenty-four different hues in all, including six shades of gray.

Other subsequent calculations associated with specific test cards and filters (as in the example of FIG. 5, discussed below) provide precise measurements of other parameters, but this first step based on the benchmark of FIG. 2 already provides a large amount of information very quickly.

In particular, immediately after the geometric identification, the color elements are used to calculate the projection's colorimetry. The results are presented in summary form by comparing the actual colors with reference data from the digital cinema standard. FIG. 3 shows these results displayed. In the example shown, the primary and complementary colors are distributed to form a hexagon and their respective positions approximate their position in the standard two-dimensional chromaticity diagram of the International Commission on Illumination. Starting from the color at the left of the hexagon and going in the clockwise direction we have successively: cyan (CY), green (VE), yellow (JA), red (RO), magenta (MA), and blue (BL). In the example of FIG. 3, the six reference colors (the primary colors red, green, blue, and the complementary colors yellow, magenta, cyan) are used to display the measured colorimetric deviation between the projection (in dashed lines) and the standard (in solid lines), with a tolerance TOL illustrated by a rectangle for each reference color. More particularly, compared to the twenty-four ideal hues of the test card, a deviation is estimated between each hue in the test card as it actually appears when projected and the ideal hue, for the six reference colors of the hexagon of FIG. 3.

It should be noted that a command COM allows automatically adjusting the chrominance of the projector (by calculating a conversion matrix adapted to the actual colors of the projection, where the dominant blues of the projected image are generally more saturated in the example shown, as is indicated by the central cross (in dashed lines) being slightly offset to the right relative to the central mark). The adjustment command may be received by a communication interface of the server SER controlling the projector PROJ, the server SER being connected to the computer PC via the local network LAN as shown in FIG. 1.

Next, a further step may involve the adjustment of the luminance distribution. FIG. 4 illustrates an example three-dimensional visualization of the luminance distribution measured by the videocamera CAM. To achieve this, a uniform white image is projected and a step is performed of calculating the brightness over the entire screen. The position of the brightest point, the maximum luminance value, and the exact form of the light distribution are obtained. Several displays are possible, two-dimensional (along the two dimensions of the screen ECR) or three-dimensional (the third coordinate z representing the relative light intensity), as is calculation of the values at certain points of the image according to what is required by the various standards. In order to measure uniformity of illumination, the processing according to this example embodiment automatically finds the brightest point and the dimmest point, which allows obtaining a three-dimensional profile of the screen illumination in order to provide a better analysis of potential problems. Thus, in the example of FIG. 4, the maximum luminance is offset towards the right of the screen, while the luminance of the left portion HN is not sufficient to meet the standard in this case (the reference HN denoting “nonstandard”).

Another step consists of calibrating the videocamera itself, to achieve good measurement results at the projection site. For the geometric identification, the same specific test card of FIG. 2 can be used in order to associate the pixels of the CCD sensor of the videocamera with specific areas of the projected image. To measure videocamera noise, the residual values of each pixel are recorded with the shutter closed. These values depend on the exposure time; the values used in the calculations depend on the exposure setting for each screen capture. For the uniformity of the light received, points identified with a reference device such as a spectrocolorimeter are measured and a vignetting model is used (natural decrease in light intensity with distance from the optical axis) for calculating the non-uniformity specific to each assembly of videocamera and lens.

For the color correction matrix, the color measurement data are read in specific areas of the screen by the abovementioned image capturing device. They are in the form of color space coordinates XYZ of the reference space of the International Commission on Illumination. These data are adjusted to account for the previously determined light intensity non-uniformities. The measurements for colors Red, Green, Blue on the videocamera sensor are also corrected for the previously noted noise. Mathematical minimization calculations relating to several tens of geometrically identified areas allow obtaining the matrix for converting from RGB to a XYZ color space system specific to the videocamera to be calibrated. In other words, we change from a conventional RGB calibration reference of a videocamera or digital camera CAM, to an XYZ coordinate system of a projection device PROJ for projecting on the screen of a room, particularly a room for movie theater showings, by a transfer function specific to the image capturing device CAM, this transfer function being obtained by calibration, as described above, of the geometric position, noise measurement, uniformity, and color correction matrix.

Another advantageous step consists of focusing the projector, assisted by the computing means PC. This focusing is done by displaying one or more smaller areas of the screen at a rapid pace. Each analyzed area is displayed and a calculation is performed to provide two curves that change according to the definition measured in this area. This definition is measured by calculating the ratio of the actual maximum gradient read in each area to the maximum theoretical gradient which is a function of the projected pattern and of the capture parameters. Referring to FIG. 5, three successive views with the details of the focusing test card displayed at the center of the image are represented with the respective changes in the two focus control curves. The thin curve CV changes with the focusing (the oscillations indicating the drawing closer to or further away from the optimal setting) and the thick curve CF shows the maximum sharpness achieved by the optimal setting. Thus, curve CV indicates a definition measurement at each moment in time, while the other curve CF shows the maximum obtained at each moment. This arrangement allows very precise remote adjustment of the projection focus. For better control of the focus, one can calculate and display the test card MG on the central area illustrated in FIG. 5 or display it on five areas (the center and four corners), or add a sixth area at the bottom center of the screen (where subtitles are typically displayed).

Thus, referring to FIG. 6 illustrating the main steps of a method within the meaning of the invention, according to one exemplary embodiment, after a calibration of the videocamera CAM (step S1) to allow obtaining its transfer function (step S2), a first step S3 may consist of controlled adjustment of the focus as described above with reference to FIG. 5. This step ensures the sharpness of the projection before any adjustments are made to the luminance in the next step S4. A white image is then projected (or the test card of FIG. 2 in an alternative embodiment) to allow obtaining a luminance distribution on the projection screen in step S4. This step can be followed, if necessary, by an adjustment of the luminance uniformity. When possible, it may be preferable to adjust the luminance uniformity before proceeding to step S6 of determining the chrominance, in particular to take into account the calibration conditions of the image capturing device CAM. However, this sequence in steps S4 and S6 is not required, as the design of the test card makes the chrominance determination sufficiently robust without necessarily passing through the luminance determination step S4.

In the example described, however, the next step S5 consists of projecting the test card MI of FIG. 2 (if it has not already been used for the step of determining the luminance distribution in step S4) in order to obtain measurements of the general chrominance deviation in the projected image in step S6, as described above with reference to FIG. 3. These last steps S4 and S6 allow characterizing the general condition of the projector and possibly determining the recommended adjustments, particularly in terms of chrominance or of a change of orientation of the projector relative to the screen for the luminance distribution. Of course, the invention is not limited to the embodiment described above by way of example; it extends to other variants.

For example, the focusing test card MG of FIG. 5 can be integrated for example at the center of the general test card MI of FIG. 2, so that only one processing with a single pass is ultimately used for all adjustments.

Similarly, the projection of a white image in order to determine the luminance distribution on the screen has been described. However, the same test card MI can also be used for this purpose as stated above.

In addition, each obtaining of results of FIGS. 4 and 5, by the respective implementation of steps S3 and S4 described above, is particularly advantageous. Thus, each step S3 and S4 implemented by the system of FIG. 1 may itself be the object of a separate protection, independently of the chrominance determination of step S6.

1. A method for determining the operation of a projector of images on a screen of a projection room, characterized in that it is implemented by computing means and comprises the steps of:
controlling the projector so as to project on the screen a test card comprising a distribution of patterns of different hues
capturing an image of the test card on the screen by an image capturing device, and
processing the captured image to determine at least one chrominance deviation of the captured image with respect to a predefined number of colors.

2. The method according to claim 1, wherein the test card comprises, at least in a peripheral portion, a distribution of colored patterns, each alternating with homologous patterns of uniform neutral color.

3. The method according to claim 1, wherein the test card comprises at least twenty-four patterns of different colors, comprising:
at least the colors of human skin tones, the sky, and foliage, and
six shades of gray.

4. The method according to claim 1, wherein the predefined number of colors is six.

5. The method according to claim 1, wherein the chrominance deviation is compared to a tolerance threshold for each color of said predefined number of colors, and in case of a deviation greater than the tolerance threshold, a man/machine interface signal of non-conformity of the projector adjustment is generated.

6. The method according to claim 5, wherein the interface signal prompts a user to confirm a command to adjust the chrominance of the projector automatically.

7. The method according to claim 1, wherein upper right, lower right, upper left, and lower left edge patterns are white in color to assist with capturing an image of the entire the test card.

8. The method according to claim 1, wherein the patterns are rectangles separated by black lines of predetermined thickness.

9. The method according to claim 1, further comprising the determination of a luminance distribution on the screen.

10. The method according to claim 9, wherein the luminance distribution is given by:
two coordinates of latitude and longitude on the screen, and
a proportion of light intensity received at each of these screen coordinates.

11. The method according to claim 9, wherein the determination of a luminance lower than a threshold in at least a portion of the screen causes the generation of a man/machine interface signal of non-conformity of the projector settings.

12. The method according to claim 1, further comprising a preliminary step of calibrating the image capturing device.

13. The method according to claim 1, further comprising a step of progressively adjusting the focus of the projector by projecting a contrasting test card.

14. A non-transitory computer program product comprising instructions for implementing the method according to claim 1 when the program is executed by a processor.

15. A system for determining the operation of a projector of images on a screen of a projection room, comprising:
a device for controlling the projector so as to project on the screen a test card comprising a distribution of patterns of different hues,
an image capturing device for capturing a digital image of the test card on the screen, and
computing means connected to the image capturing device in order to process the captured image and determine at least one chrominance deviation of the captured image with respect to a predefined number of colors.

16. The method according to claim 10, wherein the determination of a luminance lower than a threshold in at least a portion of the screen causes the generation of a man/machine interface signal of non-conformity of the projector settings.
